(19) United States
(12) Patent Application Publication
(10) Pub. No.: US 2011/0302410 A1
(43) Pub. Date: Dec. 8, 2011

(54) SECURE DOCUMENT DELIVERY

(76) Inventors: Christopher Clarke, Moncton (CA); Michael Mullen, Riverview (CA)

(21) Appl. No.: 12/795,591

(22) Filed: Jun. 7, 2010

(51) Int. Cl. H04L 9/32; H04L 9/08

(52) U.S. Cl. 713/155; 380/279; 380/46

(57) ABSTRACT

A method, machine-readable medium, and server to create a key, set an expiration event for the key to expire, send the key to a first client device to encrypt the document, authenticate a second client device that is in receipt of the encrypted document, delete the key if the expiration event has occurred, and send the key from to the authenticated second client device to decrypt the document if the expiration event has not yet occurred. For one embodiment, the key is used by client devices for encryption and decryption of the document only and is not otherwise accessible to the client devices. For one embodiment, the server facilitates sending the encrypted document to the second client device but does not retain a copy of the encrypted document.

### FIELD

The various embodiments described herein relate to the secure transfer of encrypted information using a symmetric-key algorithm. In particular, embodiments include a server that, at the request of a first client device, creates a key that is subject to an expiration event, enables the first client device to encrypt a document with the key, and facilitates the transfer of the key to a second client device if the expiration event has not occurred and upon authentication of the second client device.

### BACKGROUND

Various encryption methodologies are used to implement the secure transfer of documents over a network such as the Internet. Encryption is a process of transforming information using an algorithm or cipher to make it unreadable. Tunneling and key-based payload encryption are two predominantly used methodologies for the transfer of information (e.g. documents) over a network.

Tunneling creates an encrypted channel within an insecure network by authenticating one or both of the client device and server communicating over the channel using an asymmetric key algorithm. One common use of tunneling is for secure web sites, e.g., for banking, that perform actions using a Hypertext Transfer Protocol Secure (“HTTPS”) connection. Tunneling, however, often requires one end point of the communication to maintain a fairly sophisticated security infrastructure. As a result, tunneling is not typically a feasible option for communication between individuals. Additionally, the service that provides and maintains the secure tunnel between each end point must be completely trusted, as it will be able to access the information being transferred in an unprotected form.

Key-based payload encryption protects sensitive information by encrypting the information/payload itself, rather than the channel over which the information is sent. One or more “keys” are used by the algorithm to encrypt and decrypt the information and render it readable again. Symmetric key algorithms use identical or nearly-identical keys for both the encryption of the information as well as the decryption of the information. Asymmetric key algorithms use a different key for encryption than for decryption.

An advantage to key-based payload encryption is that the information remains protected both during and after the transaction. Additionally, this methodology does not require the sophisticated infrastructure needed for tunneling. Users, however, are typically required to create and/or maintain keys that represent their ability to encrypt and decrypt documents. These keys are meant to have a long shelf-life and, at times, can be used for a year or longer. Long-term-use keys are vulnerable to being discovered or “hacked.” Once the security of a long-term-use key has been compromised, it can be applied to any document encrypted or decrypted for or by the user who's key has been compromised—including documents previously sent, currently being sent, and yet to be sent using the compromised key.

### BRIEF DESCRIPTION OF THE DRAWINGS

The present invention is illustrated by way of example and not limitation in the figures of the accompanying drawings, in which like references indicate similar elements, and in which:

FIG. 1 is an exemplary block diagram of a system in which embodiments may be implemented.

FIG. 2 is an exemplary block diagram of a server in which embodiments may be implemented.

FIG. 3 is a flow chart illustrating an exemplary process of a server creating, transferring, and deleting a key according to an embodiment of the invention.

FIG. 4 is a flow chart illustrating an exemplary process of a server transferring an encrypted document according to an embodiment of the invention.

FIG. 5 is a flow chart illustrating an exemplary process of a client device transferring an encrypted document according to an embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

A method, machine-readable medium, and server are described for creating a key, setting an expiration event for the key to expire, sending the key to a first client device to encrypt the document, authenticating a second client device that is in receipt of the encrypted document, deleting the key if the expiration event has occurred, and sending the key from to the authenticated second client device to decrypt the document if the expiration event has not yet occurred. For one embodiment, the key is used by client devices for encryption and decryption of the document only and is not otherwise accessible to the client devices. For one embodiment, the server facilitates sending the encrypted document to the second client device but does not retain a copy of the encrypted document.

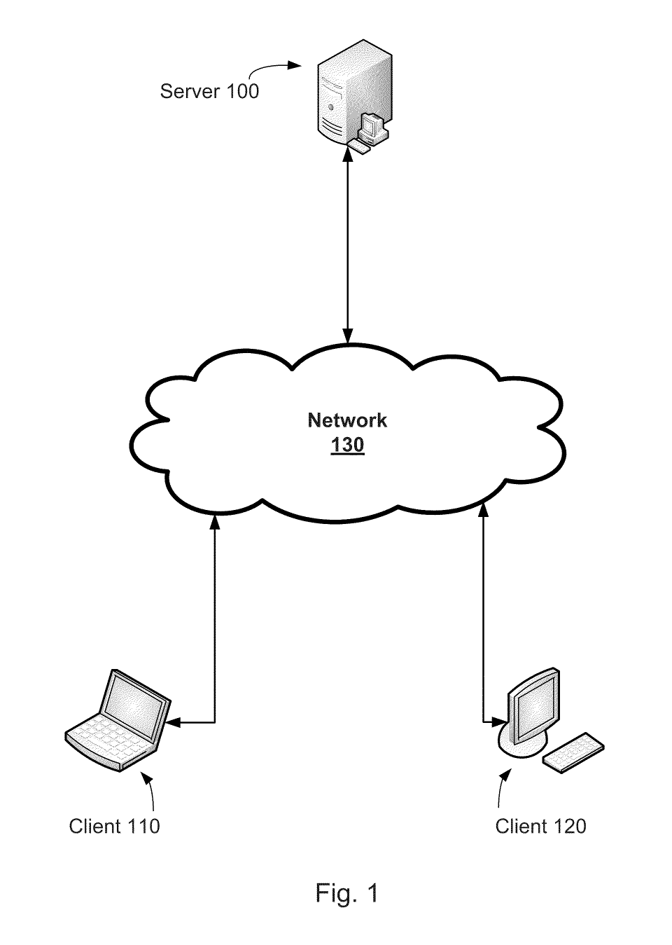

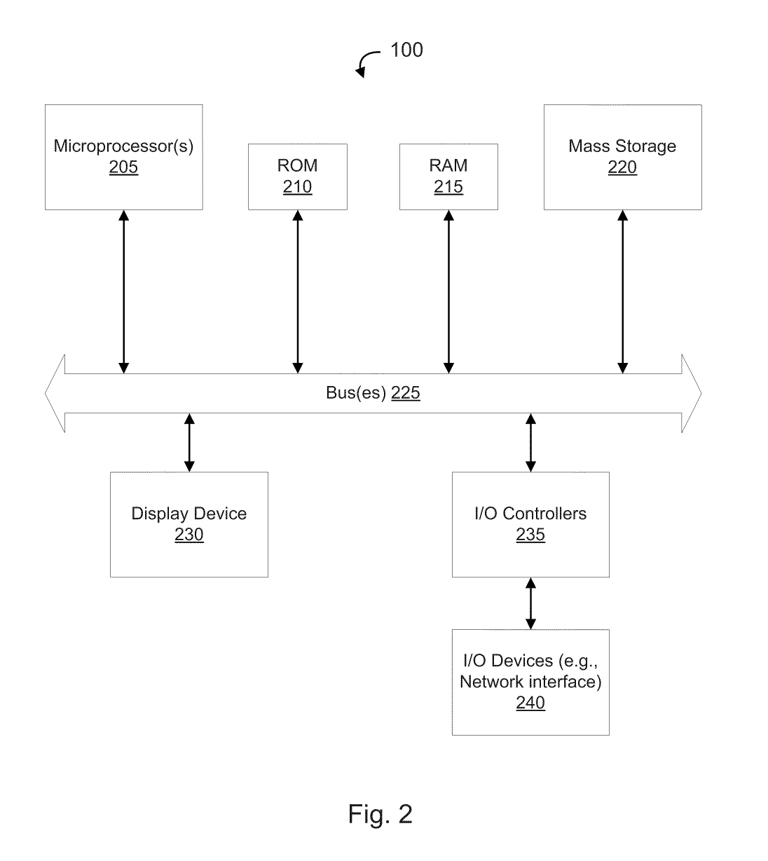

FIG. 1 is an exemplary block diagram of a system in which embodiments of the invention may be implemented. A server 100 is coupled to client devices 110 and 120 over a network 130. The exemplary server 100 is a computer device designed to provide services to client devices and will be described in greater detail below with reference to FIG. 2. The exemplary client devices 110 and 120 are generally representative of personal or client device computers, mobile devices, (e.g., mobile cellular device, PDA, satellite phone, mobile VoIP device), and other devices capable of sending and receiving documents over a network. The network 130 is representative of any computer network that allows devices to communicate and transfer documents and may be a wired, wireless, or combination of wired and wireless connections. Examples of the network 130 include the Internet, cellular, satellite, cable, a local area network (“LAN”), Wide Area Network (“WAN”), Metropolitan Area Network (“MAN”), Personal Area Network (“PAN”), Virtual Private Network (“VPN”), Campus Area Network (“CAN”), Storage Area Network (“SAN”), or a combination thereof.

FIG. 2 is an exemplary block diagram of a server 100 in which embodiments of the invention may be implemented. The exemplary server 100 is generally representative of dedicated server hardware, a general purpose computer running a server operating system, or a combination thereof. The exemplary server 100 includes at least a processor 205 (e.g., a Central Processing Unit (CPU), a core of a multi-core processor, or a combination thereof), a Read Only Memory (ROM) 210, a Random Access Memory (RAM) 215, and a Mass Storage 220 (e.g., a hard drive) which communicate with each other via a bus or buses 225.

Any of one or more cores in one or more processors 205 is coupled to one or more buses 225, e.g., one or more PCI buses or other peripheral buses known in the art to send and receive signals to I/O controllers 235 and I/O devices 240 attached to the one or more buses. The I/O devices 240 may include a network interface device, modem, CD drive, mouse, a keyboard, and other known input, output, and/or I/O peripheral devices. The network interface device may include a network card, network adapter, network interface controller (NIC), network interface card, LAN adapter, etc. and is a computer hardware component designed to allow the server 100 to communicate over a network 130.

For one embodiment, the server 100 also includes a Display Device 230 (e.g., Liquid Crystal Display (LCD) or a Cathode Ray Tube (CRT) or a touch screen, plasma display, light-emitting diode (LED), organic light-emitting diode (OLED), etc.).

The exemplary client devices 110 and 120 may have many similar components to those described for the server 100.

For one embodiment, the operations, processes, modules, methods, and systems described and shown in the accompanying figures of this disclosure are intended to operate on one or more exemplary servers 100 or client devices 110 and 120 as sets of instructions (e.g., software), also known as computer implemented methods. For example, in the exemplary server 100, the mass storage 220 includes a machine-readable (or computer-readable) storage medium on which is stored one or more sets of instructions (e.g. software) embodying any one or more methodologies or functions. The software may also reside, completely or at least partially, within ROM 210 or RAM 215 and/or within the processor 205 during execution thereof by the server 100—the ROM 210, RAM 215, and within the processors 205 also constituting machine-readable storage media. The software may further be transmitted or received over a network (not shown) via a network interface device 240. Similarly, client devices 110 and 120 may utilize mass storage, ROM, RAM, storage within a processor, or other form of storage medium and execute instructions stored on one or more of those storage mediums.

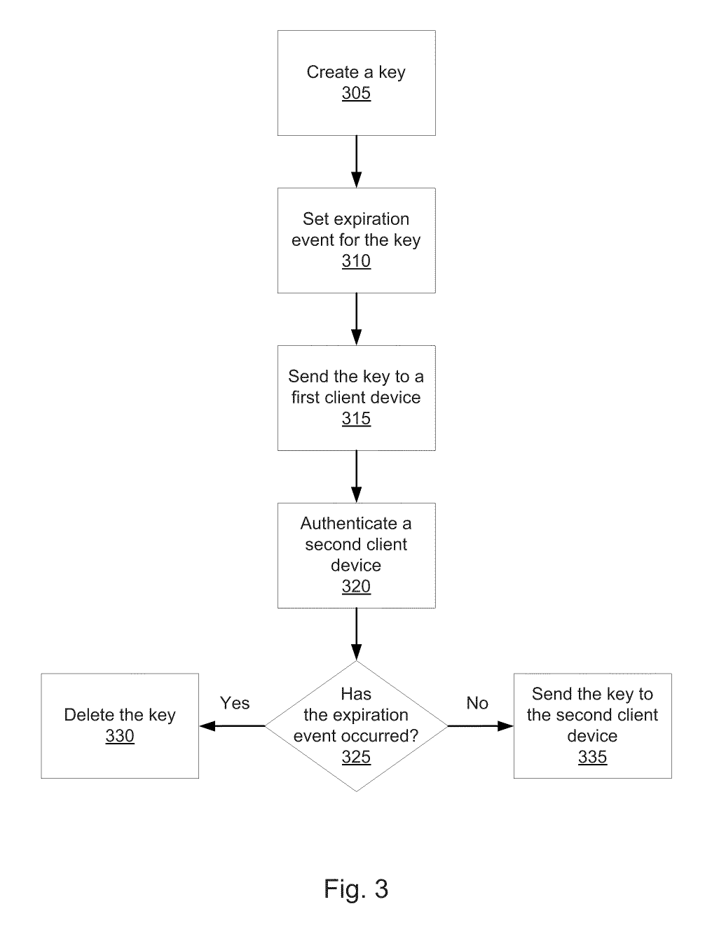

FIG. 3 is a flow chart illustrating an exemplary process of a server creating, transferring, and deleting a key according to an embodiment of the invention. A first client device 110 sends a request to the server 100 to create a key at block 305. This may occur subsequent to the first client device 110 creating and/or logging into an account with the server 100 or the server 100 authenticating or otherwise establishing an identity of the user of the first client device 110. The creation of the key may be the product of a random or pseudorandom key generator (collectively referred to herein as a random number generator or random number key generator). For one embodiment, the key is created according to a symmetric-key algorithm—e.g., Twofish, Blowfish, Serpent, Advanced Encryption Standard (“AES”), Data Encryption Standard (“DES”), CAST-128/CAST5, RC4, Triple Data Encryption Standard or Triple Data Encryption Algorithm (“TDES/TDEA”), International Data Encryption Algorithm (“IDEA”), etc.

For one embodiment, the server determines the geographical location of the first client device 110 and the geographical location of a second client device 120 that will be the recipient of the document encrypted by the key. The bit size of the key created is then dependent upon the geographic location of at least one of the first and second client devices 110 and 120. The determination of the geographical location of the second client device 120 may be supplied by the user of the first client device 110 and later confirmed during the authentication of the second client device 120 as described below.

At the request of the first client device 110, or as a default operation, the server 100 sets an expiration event for the key at block 310. For example, the expiration event for the key may include one or more of the following: an expiration time based upon a time the key was created, an expiration time based upon a time the key was sent to the first client device, an expiration time based upon a time the key was sent to the second client device, an expiration time based upon a time the first client device encrypts the document, an expiration time based upon a time the encrypted document was sent to the second client device, an expiration time based upon a time the second client device decrypts the document, a predetermined number of uses of the key to decrypt the encrypted document, a predetermined number of failed attempts to authenticate the second user, a request from the first client device to erase the key, and a request from the second device to erase the key.

The server 100 sends the key to the first client device 110 to encrypt a document at block 315. For one embodiment, the document is encrypted according to a symmetric-key algorithm—e.g., Twofish, Blowfish, Serpent, AES, DES, CAST-128/CAST5, RC4, TDES/TDEA, IDEA, etc.

For one embodiment, the first client device 110 may use the key to encrypt a document but the key is not otherwise accessible to the first client device 110. For example, encryption may be facilitated by running a client-side program, plug-in to another application (e.g., a web browser), or script in a programming/scripting language such as Java™ or Flash® in order to limit the first client device's ability to access or control the key. For example, the client-side program may be constrained, limited, or otherwise controlled by the server 100. Likewise, the server 100 may respond only requests to create or send a key if the request is originated from a recognized client-side program. For one embodiment, the key is deleted from the first client device 110 after the document has been encrypted. For one embodiment, the communication between the client-side program and the server 100 may be facilitated through tunneling encryption maintained by the server 100 to provide additional protection of the key.

The server 100 authenticates the second client device 120 at block 320. Authentication of the second client device 120 may include the first client device 110 providing an answer to a security question to the server 100, the second client device 120 providing an answer to the same security question to the server 100, and the server 100 comparing the answers as provided by the first and second client devices 110 and 120. Alternatively, or in addition to a security question, the second client device 120 may login to an account created with the server 100 based upon an email account associated with the user of the second client device 120 and the server 100 may compare the email account and an email account to receive the encrypted document as indicated by the first client device 110.

For one embodiment, the authentication of the second client device 120 may also include determining the geographical location of the second client device 120. If the geographical location of the second client device 120 does not match the geographical location supplied by the first client device 110 for the second client device 120 or a geographical location that is compatible with the bit size of the key, the server 100 may not authenticate the second client device 120 or the server may not otherwise transmit the key to the second client device 120.

Prior to sending the key to the second client device 120, the server 100 determines if an expiration event for the key has occurred at block 325. If an expiration event has occurred, the server 100 deletes the key at block 330 and the key is not transmitted to the second client device 120.

On the other hand, if an expiration event has not occurred, the server 100 sends the key to the second client device 335 to decrypt the document. For one embodiment, similar to the transmission of the key to the first client device 110, the second client device 120 may use the key to decrypt the document but the key is not otherwise accessible to the second client device 120. For example, decryption may be facilitated by running a client-side program or script in a programming/scripting language such as Java™ or Flash® in order to limit the second client device's ability to access or control the key. Similar to the description above, the client-side program in the second client device 120 may be constrained, limited, or otherwise controlled by the server 100. Likewise, the server 100 may respond only requests to create or send a key if the request is originated from a recognized client-side program. For one embodiment, the key is deleted from the second client device 120 after the document has been decrypted. For one embodiment, the communication between the client-side program and the server 100 may be facilitated through tunneling encryption maintained by the server 100 to provide additional protection of the key.

The server 100, after sending the key to the second client device 120, may continue to monitor expiration events for the key to determine when the key should be deleted from the server 100 and, therefore, no longer be accessible to the second client device 120 (or any other client device). For one embodiment, the document returns to an encrypted state if the document, after being decrypted and opened, is closed. As a result, if the second client device 120 tries to open the encrypted document again, the process of authenticating and/or requesting the key from the server 100 is repeated.

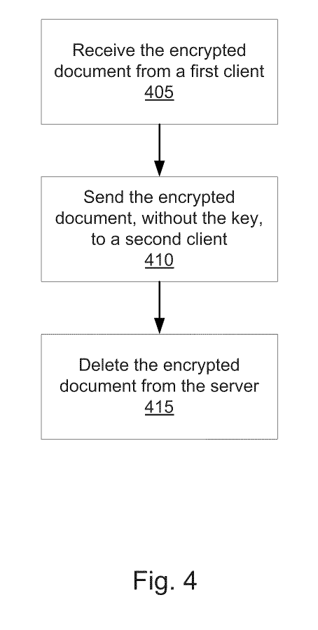

FIG. 4 is a flow chart illustrating an exemplary process of a server transferring an encrypted document according to an embodiment of the invention. For one embodiment, prior to the second client device 120 requesting authentication and transmission of the key from the server 100, the first client device 110 causes the encrypted document to be sent to the second client device 120 without the key. For one embodiment, the first client device 110 may send or otherwise transfer the encrypted document directly to the second client device 120.

Alternatively, the server 100 receives the encrypted document from the first client device 110 to facilitate the transfer of the encrypted document to the second client device 120 at block 405. The first client device 110 provides the server 100 with instructions of how to deliver the encrypted document to the second client device 120—e.g., an email address, an file transfer protocol (“FTP”) address, etc. The server 100 then sends the encrypted document, without the key, to the second client device at block 410. Upon sending the encrypted document, the server 100 deletes the encrypted document from the server at block 415.

Although the sending of an encrypted document, sending of the key, and authentication of the second client device 120 are described in the examples above as including only a single second client device 120, embodiments may include the use of multiple client devices. For example, the encrypted document may be downloaded from an email account on one client device, transferred by the recipient to an additional client device, and then decrypted on that additional client device.

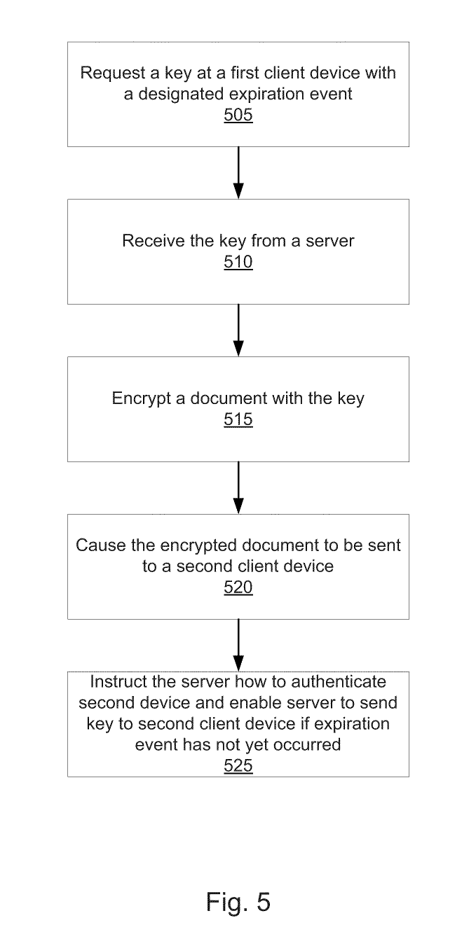

FIG. 5 is a flow chart illustrating an exemplary process of a client device transferring an encrypted document according to an embodiment of the invention. The first client device 110 sends a request to the server 100 to create a key at block 505. The request to create a key includes the designation of at least one expiration event for the key. This may occur subsequent to the first client device 110 logging into an account with the server 100 or the server 100 authenticating or otherwise establishing an identity of the user of the first client device 110 and/or geographical location of the first client device 110.

The first client device 110 receives the key from the server 100 at block 510 and encrypts a document with the key at block 515. For one embodiment, the first client device 110 may use the key to encrypt a document but the key is not otherwise accessible to the first client device 110. For example, encryption may be facilitated by running a client-side program or script in a programming/scripting language such as Java™ or Flash® in order to limit the first client device's ability to access or control the key (as described above). For one embodiment, the key is deleted from the first client device 110 after the document has been encrypted.

The first client device 110 causes the encrypted document to be sent to the second client device 120 at block 520. As described above, this may include sending or transferring the document to the second client device 120 directly or by having the server 100 facilitate the transfer.

The first client device 110 may instruct the server 100 on how to authenticate the second client device 120 at block 525 in order to enable the server 100 to send the key to the second client device 120 if an expiration event has not yet occurred. For one embodiment, this may include the first client device 110 providing the answer to a security question so that the server may compare an answer provided by the second client device 120 in the authentication process. Alternatively, or in addition to a security question, the first client device may provide an email address to receive the encrypted document and, for authentication, the second client device 120 may login to an account created with the server 100 based upon an email account and the server 100 may compare the email account used for logon and the email address as provided by the first client device 110.

In the foregoing specification, the invention has been described with reference to specific exemplary embodiments thereof. It will be evident that various modifications may be made thereto without departing from the broader spirit and scope of the invention as set forth in the following claims. An article of manufacture may be used to store program code providing at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention. The specification and drawings are, accordingly, to be regarded in an illustrative sense rather than a restrictive sense.

What is claimed is:

1. A method for secure delivery of a document, the method comprising:
creating, by a server, a key;
setting an expiration event for the key to expire;
sending the key from the server to a first client device to encrypt the document;
authenticating, by the server, a second client device;
determining if the expiration event has occurred;
deleting, by the server, the key if the expiration event has occurred; and
sending the key from the server to the authenticated second client device to decrypt the document if the expiration event has not yet occurred.

2. The method of claim 1, wherein the key is used by the first client device only to encrypt the document and is not otherwise accessible to first client device.

3. The method of claim 1, wherein the key is used by the second client device only to decrypt the document and is not otherwise accessible to second client device.

4. The method of claim 1, wherein the expiration event includes one or more of the following: an expiration time based upon a time the key was created, an expiration time based upon a time the key was sent to the first client device, an expiration time based upon a time the key was sent to the second client device, an expiration time based upon a time the encrypted document was sent to the second client device, an expiration time based upon a time the first client device encrypts the document, an expiration time based upon a time the second client device decrypts the document, a predetermined number of uses of the key to decrypt the encrypted document, a predetermined number of failed attempts to authenticate the second user, a request from the first client device to erase the key, and a request from the second device to erase the key.

5. The method of claim 1, wherein the bit size of the key is dependent upon the geographical location at least one of the first or second client device.

6. The method of claim 1, further comprising:
receiving, by the server, the encrypted document;
sending the encrypted document from the server to the second client device without the key; and
deleting, from the server, the encrypted document after the encrypted document has been sent to the second client device.

7. The method of claim 1, wherein the first client device provides an answer to a security question and the authentication of the second client device includes the second client device providing the answer to the security question as provided by the first client device.

8. The method of claim 1, wherein authentication of the second client device includes the second client device logging into an account with the server, the account being associated with an email address to which the encrypted document was sent.

9. The method of claim 1, wherein the key is created using a random number generator.

10. A method for secure delivery of a document, the method comprising:
sending, by a first client device, a request to a server to create a key and an expiration event for the key to expire, wherein the server is to delete the key in response to the expiration event;
receiving the key from the server;
encrypting, by the first client device, the document using the key;
causing the encrypted document to be sent to a second client device without the key; and
sending instructions to the server on how to authenticate the second client device and enable the server to send the key to the authenticated second client device if the expiration event has not yet occurred.

11. The method of claim 10, wherein the key is used by the first client device only to encrypt the document and is not otherwise accessible to first client device.

12. The method of claim 10, wherein the expiration event includes one or more of the following: an expiration time based upon a time the key was created, an expiration time based upon a time the key was sent to the first client device, an expiration time based upon a time the key was sent to the second client device, an expiration time based upon a time the encrypted document was sent to the second client device, an expiration time based upon a time the first client device encrypts the document, an expiration time based upon a time the second client device decrypts the document, a predetermined number of uses of the key to decrypt the encrypted document, a predetermined number of failed attempts to authenticate the second user, a request from the first client device to erase the key, and a request from the second device to erase the key.

13. The method of claim 10, wherein the instructions include an answer to a security question and where the authentication of the second client device includes the second client device providing the answer to the security question as provided by the first client device.

14. A machine-readable storage medium storing instructions that, when executed, cause a server to perform a method comprising:
creating a key;
setting an expiration event for the key to expire;
sending the key to a first client device to encrypt a document;
authenticating a second client device;
determining if the expiration event has occurred;
deleting the key if the expiration event has occurred; and
sending the key to the authenticated second client device to decrypt the document if the expiration event has not yet occurred.

15. The machine-readable storage medium of claim 14, wherein the key is used by the first client device only to encrypt the document and is not otherwise accessible to first client device.

16. The machine-readable storage medium of claim 14, wherein the key is used by the second client device only to decrypt the document and is not otherwise accessible to second client device.

17. The machine-readable storage medium of claim 14, wherein the expiration event includes one or more of the following: an expiration time based upon a time the key was created, an expiration time based upon a time the key was sent to the first client device, an expiration time based upon a time the key was sent to the second client device, an expiration time based upon a time the encrypted document was sent to the second client device, an expiration time based upon a time the first client device encrypts the document, an expiration time based upon a time the second client device decrypts the document, a predetermined number of uses of the key to decrypt the encrypted document, a predetermined number of failed attempts to authenticate the second user, a request from the first client device to erase the key, and a request from the second device to erase the key.

18. The machine-readable storage medium of claim 14, wherein the bit size of the key is dependent upon the geographical location at least one of the first or second client device.

19. The machine-readable storage medium of claim 14, further comprising:
receiving the encrypted document;
sending the encrypted document to the second client device without the key; and
erasing the encrypted document after the encrypted document has been sent to the second client device.

20. The machine-readable storage medium of claim 14, wherein the first client device provides an answer to a security question and the authentication of the second client device includes the second client device providing the answer to the security question as provided by the first client device.

21. The machine-readable storage medium of claim 14, wherein authentication of the second client device includes the second client device logging into an account with the server, the account being associated with an email address to which the encrypted document was sent.

22. The machine-readable storage medium of claim 14, wherein the key is created using a random number generator.

23. A machine-readable storage medium storing instructions that, when executed, cause a first client device to perform a method comprising:
sending a request to a server to create a key and an expiration event for the key to expire, wherein the server is to delete the key in response to the expiration event;
receiving the key from the server;
encrypting a document using the key;
causing the encrypted document to be sent to a second client device without the key; and
sending instructions to the server on how to authenticate the second client device and enable the server to send the key to the authenticated second client device if the expiration event has not yet occurred.

24. The method of claim 23, wherein the key is used by the first client device only to encrypt the document and is not otherwise accessible to first client device.

25. The method of claim 23, wherein the expiration event includes one or more of the following: an expiration time based upon a time the key was created, an expiration time based upon a time the key was sent to the first client device, an expiration time based upon a time the key was sent to the second client device, an expiration time based upon a time the encrypted document was sent to the second client device, an expiration time based upon a time the first client device encrypts the document, an expiration time based upon a time the second client device decrypts the document, a predetermined number of uses of the key to decrypt the encrypted document, a predetermined number of failed attempts to authenticate the second user, a request from the first client device to erase the key, and a request from the second device to erase the key.

26. The method of claim 23, wherein the instructions include an answer to a security question and where the authentication of the second client device includes the second client device providing the answer to the security question as provided by the first client device.

27. A server comprising:
a processor; and
a memory, coupled to the processor, storing instructions, which when executed by the system, causes the processor to
create a key,
set an expiration event for the key to expire,
send the key from the server to a first client device to encrypt the document,
authenticate a second client device,
determine if the expiration event has occurred,
delete the key if the expiration event has occurred, and
send the key from the server to the authenticated second client device to decrypt the document if the expiration event has not yet occurred.

28. The server of claim 27, wherein the key is used by the first client device only to encrypt the document and is not otherwise accessible to first client device.

29. The server of claim 27, wherein the key is used by the second client device only to decrypt the document and is not otherwise accessible to second client device.

30. The server of claim 27, wherein the expiration event includes one or more of the following: an expiration time based upon a time the key was created, an expiration time based upon a time the key was sent to the first client device, an expiration time based upon a time the key was sent to the second client device, an expiration time based upon a time the encrypted document was sent to the second client device, an expiration time based upon a time the first client device encrypts the document, an expiration time based upon a time the second client device decrypts the document, a predetermined number of uses of the key to decrypt the encrypted document, a predetermined number of failed attempts to authenticate the second user, a request from the first client device to erase the key, and a request from the second device to erase the key.

31. The server of claim 27, wherein the bit size of the key is dependent upon the geographical location at least one of the first or second client device.

32. The server of claim 27, wherein the instructions further cause the processor to:
receive the encrypted document;
send the encrypted document to the second client device without the key; and
delete the encrypted document after the encrypted document has been sent to the second client device.

33. The server of claim 27, wherein the first client device provides an answer to a security question and the authentication of the second client device includes the second client device providing the answer to the security question as provided by the first client device.

34. The server of claim 27, wherein authentication of the second client device includes the second client device logging into an account with the server, the account being associated with an email address to which the encrypted document was sent.

35. The server of claim 27, wherein the key is created using a random number generator.
